(19) United States
(12) Patent Application Publication
(10) Pub. No.: US 2026/0238277 A1
(43) Pub. Date: Aug. 13, 2026

(54) SYSTEMS AND METHODS FOR CHANNEL SOUNDING AND CHANNEL STATE INFORMATION (CSI) FEEDBACK FOR DISTRIBUTED MULTIPLE INPUT/MULTIPLE OUTPUT (MIMO) PRECODING

(71) Applicant: ZTE CORPORATION, Shenzhen, Guangdong (CN)

(72) Inventor: Ning WEI, Shenzhen (CN)

(21) Appl. No.: 19/154,397

(22) PCT Filed: Feb. 13, 2023
(86) PCT No.: PCT/CN2023/075762

§ 371 Date: Aug. 7, 2025

(51) Int. Cl. H04B 7/06; H04L 5/00

(52) U.S. Cl. CPC H04B 7/0626; H04L 5/0048

(57) ABSTRACT

Presented are systems and methods for channel sounding and channel state information (CSI) feedback for distributed multiple input/multiple output (MIMO) precoding. A first one of a plurality of wireless communication devices can send a first reference signal to a wireless communication node. The first wireless communication device can receive a second reference signal from the wireless communication node. The first wireless communication device can send a report comprising signaling of indicating channel correlation information associated with the plurality of wireless communication devices to the wireless communication node.

### CROSS-REFERENCE TO RELATED APPLICATION

This disclosure is a national stage filing under 35 U.S.C. § 371 of international application number PCT/CN2023/075762, filed on Feb. 13, 2023, the entire disclosure of which is incorporated herein by reference.

### TECHNICAL FIELD

The disclosure relates generally to wireless communications, including but not limited to systems and methods for channel sounding and channel state information (CSI) feedback for distributed multiple input/multiple output (MIMO) precoding.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium. A first one of multiple wireless communication devices (e.g., UEs) can send/transmit/provide/signal/communicate a first reference signal to a wireless communication node (e.g., base station (BS), distributed node, gNB, or transmission and reception point (TRP)). The first wireless communication device can receive/obtain/acquire/get a second reference signal from the wireless communication node. The first wireless communication device can send a report to the wireless communication node. The report can include/comprise signaling of/for indicating channel correlation information associated with the plurality of wireless communication devices.

In some implementations, the first reference signal can include a Sounding Reference Signal (SRS). In some implementations, the second reference signal can include a precoded Channel State Information Reference Signal (CSI-RS).

In some implementations, the channel correlation information can include a matrix with dimensions. In some implementations, at least one of the dimensions may be determined based on a number of the plurality of wireless communication devices. In some implementations, at least one of the dimensions may be relevant with a number of antennas, streams, or panels of any of the plurality of wireless communication devices. In some implementations, at least one of the dimensions may be determined based on a number configured by the wireless communication node for the first wireless communication device.

In some implementations, the matrix can be comprised of a plurality of codebook vectors. In some implementations, the matrix can be comprised of a plurality of quantized vectors. In some implementations, the signaling can include/comprise a plurality of indices mapping to bases for representing channel correlation information. In some implementations, the signaling may include a plurality of parameters for quantizing channel correlation information.

At least one aspect is directed to a system, method, apparatus, or a computer-readable medium. A wireless communication node (e.g., BS) can receive a first reference signal from each of a plurality of wireless communication devices (e.g., UEs). The wireless communication node can send a second reference signal to at least a first one of the plurality of wireless communication devices. The wireless communication node can receive a report from the first wireless communication device. The report can include signaling of indicating channel correlation information associated with the plurality of wireless communication devices.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example of a distributed massive MIMO network, in accordance with some embodiments of the present disclosure;

FIG. 4 illustrates an example flow diagram for a channel information acquisition procedure, in accordance with some embodiments of the present disclosure;

FIG. 5 illustrates an example grid of time-frequency-domain resource elements, in accordance with some embodiments of the present disclosure;

FIG. 6 illustrates an example operation using Hadamard products, in accordance with some embodiments of the present disclosure; and

FIG. 7 illustrates a flow diagram of an example method for channel sounding and channel state information (CSI) feedback for distributed MIMO precoding, in accordance with an embodiment of the present disclosure.

### DETAILED DESCRIPTION

### 1. Mobile Communication Technology and Environment

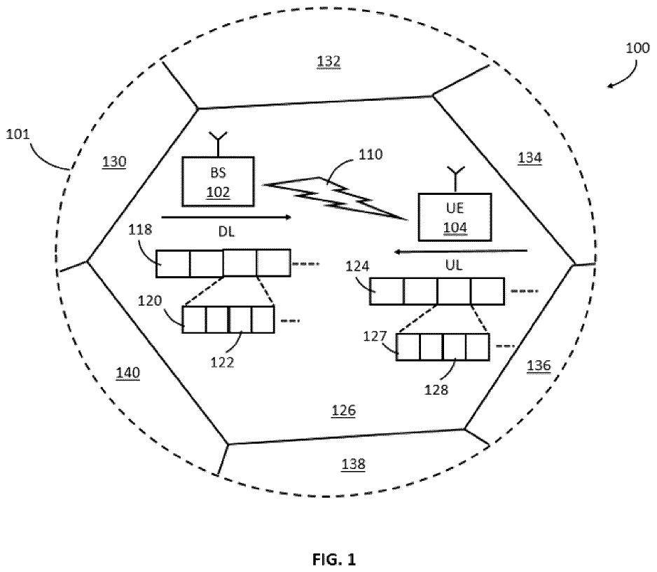

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

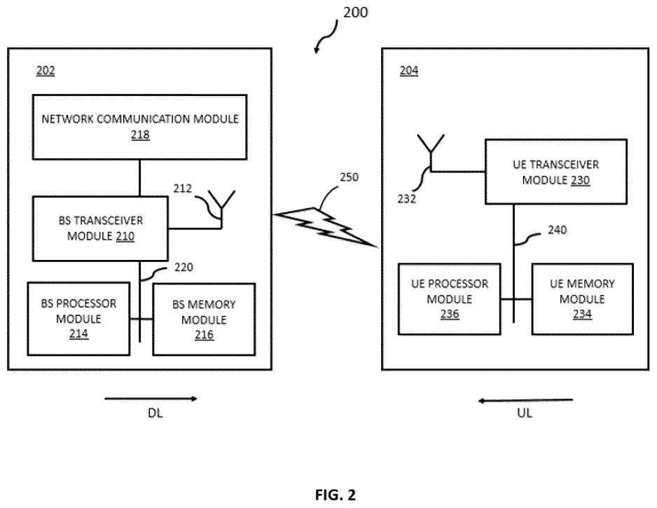

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Channel Sounding and CSI Feedback for Distributed MIMO Precoding

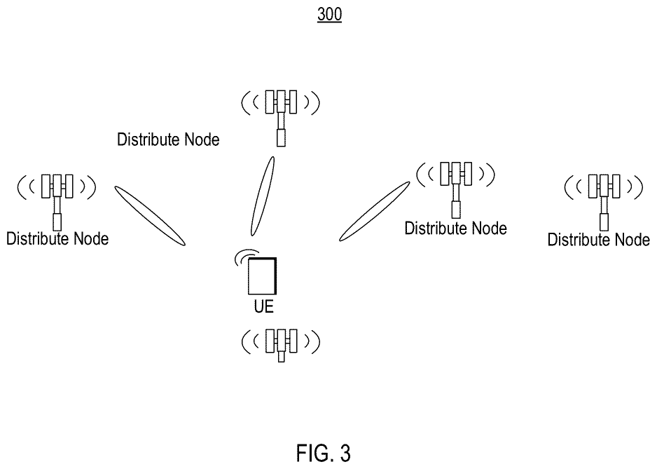

Referring to FIG. 3, depicted is an example of a distributed massive multiple input/multiple output (MIMO) network 300. In certain environments, distributed massive MIMO (e.g., sometimes referred to or known as an advanced MIMO technology) may be introduced/discussed/utilized to provide (or develop a vision of) ubiquitous data service to individual access users (e.g., UEs 104 or wireless communication devices). Compared to certain distributed MIMO technologies (e.g., canonical distributed MIMO technology), distributed massive MIMO may be expected to frequently provide relatively larger/greater/higher quantities of macro-diversity gains from softly programming electromagnetic signal propagation, which may be built/developed on channel precoding-based (e.g., coherent) transmission at the physical layer. A range (or a certain number) of channel precoding schemes/approaches/methods/configurations depending on local channel state information may be devised or provided for supporting the coherent transmission of distributed massive MIMO.

However, in multi-user scenarios/situations/environments, most of the applied channel precoding schemes may undergo/incur or result in performance loss, e.g., from residual crossing interference. In certain distributed massive MIMO systems/environments, the amount/number of local channel state information (CSI) exchange (e.g., sometimes referred to as channel information exchange (CIE)) between distributed nodes/local nodes/BSs 102/access points (APs) may be desired for performing successful channel precoding without crossing interference. For instance, the distributed precoding of the distributed massive MIMO environments may involve the acquisition of complete channel information (e.g., the amount of channel state information), rendering or resulting in a relatively heavy communication overhead/load of implementing the CIE between the BSs 102/distributed nodes. Further, the ideal CSI exchange strategy may be at least partially prohibited/blocked/restricted due to various requirements on latency and communication overhead. Hence, the systems and methods of the technical solution can provide the techniques, features, and/or operations discussed herein to reduce the amount of CIE for the distributed massive MIMO.

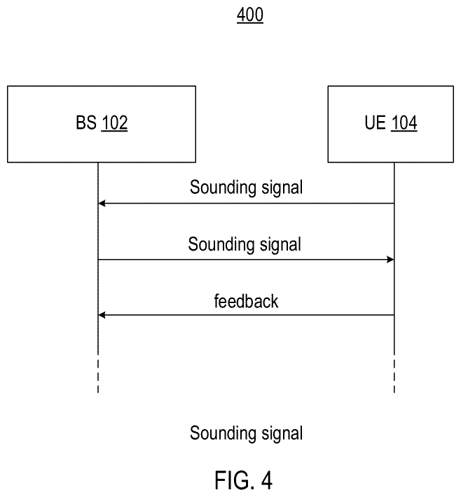

Referring to FIG. 4, depicted is an example flow diagram 400 for a channel information acquisition procedure. The flow diagram 400 can include features, operations, or procedures performed by the BS 102 (e.g., distributed node, gNB, TRP, local node, or AP) and the UE 104. The BS 102 can be in communication with the UE 104 (among other UEs 104) to exchange/communicate/provide information or data. As an overview, the BS 102 can receive a sounding signal from the UE 104. The BS 102 can send a sounding signal to the UE 104. The BS 102 can receive feedback from the UE 104. The BS 102 and the UE 104 can perform the features discussed herein to reduce the amount of CIE for/in the distributed massive MIMO network 300, for example.

### Example Step for UL Sounding Signal

In various implementations, the UE 104 can transmit/send/provide/communicate a sounding signal (e.g., uplink (UL) sounding signal or the first sounding signal) to the BS 102/distributed node. The BS 102 can receive/obtain/acquire/get the sounding signal from the UE 104. In some implementations discussed herein, a signal (or at least a part of the signal) transmitted by the BS 102 and/or the UE 104 that includes/contains pilots for channel estimation can be referred to as the reference signal or training symbol. In some cases, the UL sounding signal may be referred to or referenced as a sounding reference signal (SRS), which is a specific category of reference signal/training symbol. In some arrangements, the UL sounding signal can include at least one pilot. The pilot discussed in the present disclosure can correspond to or be provided as a predefined signal to estimate/determine channel information between the BS 102 and the UE 104.

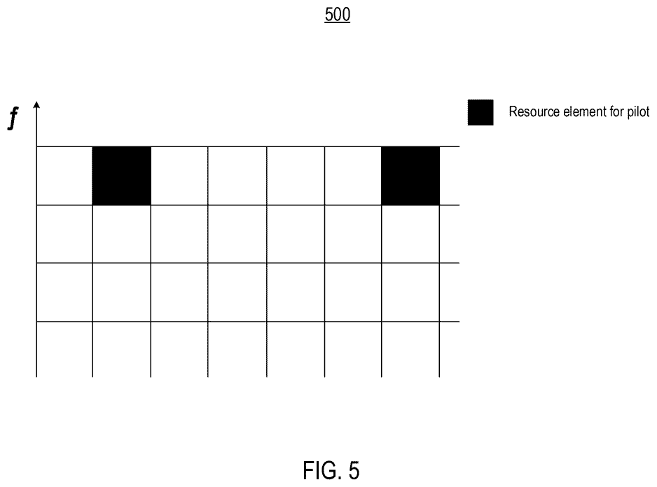

Referring to FIG. 5, depicted is an example grid 500 of time-frequency-domain resource elements. In some configurations, if pilots (or reference signals) of the (UL) sounding signal from individual UEs 104 are transmitted across the same resource elements (e.g., time-frequency resources), the UE 104 may utilize a predetermined orthogonal pilot sequence aimed to/for or configured to separate/split/divide/assort at least one received signal into pilot-sequence components from multiple UEs 104 at the BS 102 side. In some arrangements, if the inner-product between pilot sequences comprised/consisting of real/complex numbers is zero, each of the pilot sequences can be referred to as an orthogonal pilot sequence. Otherwise, each of such pilot sequences may be referred to as a non-orthogonal pilot sequence. In some arrangements, a pilot sequence transmitted by a specific UE 104 may be referred to as the pilot sequence component. In some cases, the UE 104 may utilize a predetermined non-orthogonal pilot sequence, for instance, if/when pilots carried in the UL sounding signal occupy/situate/reside in/on different resource elements.

### Example Step for DL Sounding Signal

Subsequent to receiving the UL sounding signal(s) from one or more UEs 104, the BS 102 can process the UL sounding signal(s) for the UEs 104 to determine/identify the channel response and/or precode. Responsive to the determination of the channel response and/or precode, the BS 102 can transmit a DL sounding signal (e.g., sometimes referred to as a second sounding signal) with precoded pilots to the UE 104 (among other UEs 104).

In some cases, the DL sounding signal can correspond to or include a CSI reference signal (CSI-RS), which may be another category of reference signal/training symbol. In some configurations, the pilots can be integrated into CSI-RS. In some configurations, the pilots can be integrated into one or more training symbols. In some cases, the precoded pilots can be referred to as the precoded CSI-RS/training symbol. The each/independent BS 102/distributed node (e.g., denoted as m) can estimate/determine the channel response

$${H}_{m}^{k}$$

of the UE 104 (e.g., denoted as k) as a function of the transmitted/sent/provided original/initial UL pilot sequence

$${S}_{m}^{k}$$

and the received/obtained pilot sequence

$${Y}_{m}^{k} .$$

For example, the following formula/function can be used by the BS 102 to determine the channel response:

$${H}_{m}^{k} = f ( {Y}_{m}^{k} , {S}_{m}^{k} ) \qquad ( 1 )$$

In formula (1), the denoted ƒ can represent or indicate a function designed/configured/purposed for channel estimation (e.g., channel information estimation). In some cases, if the pilots of the UL sounding signal are transmitted across two or more layers, the BS 102 can or may be expected to separate the received pilots (of the UL sounding signal from the UE 104) into multiple/different components on the layer dimension before/prior to performing the channel estimation.

Subsequently or responsive to separating the received pilots, the BS 102 ‘m’ may carry out/perform/execute/initiate a transformation from

$${H}_{m}^{k} to Φ ( {H}_{m}^{k} ) ,$$

e.g., for masking/precoding an original DL pilot sequence

$${\hat{S}}_{m}^{k} .$$

For example, responsive to separating the receiving pilot, the BS 102 can use the following formula to mask/precode an original DL pilot sequence:

$${\tilde{S}}_{m}^{k} = Φ ( {H}_{m}^{k} ) ⊗ {\hat{S}}_{m}^{k} \qquad ( 2 )$$

The element Φ( . . . ) of formula (2) can represent or denote a transformation function, where the element ⊗ can denote the Hadamard product or operation. In some cases, a normalized function

$$\tilde{Φ} ( {H}_{m}^{k} )$$

can be considered as a substitution/replacement of

$$Φ ( {H}_{m}^{k} ) .$$

In such cases, the formula (2) may be updated or replaced with the following formula:

$${\tilde{S}}_{m}^{k} = \tilde{Φ} ( {H}_{m}^{k} ) ⊗ {\hat{S}}_{m}^{k} = \frac{Φ ( {H}_{m}^{k} )}{M ‖ {H}_{m}^{k} ‖ ‖ Φ ( {H}_{m}^{k} ) ‖} ⊗ {\hat{S}}_{m}^{k} \qquad ( 3 )$$

In formula (3), the operational ∥ . . . ∥ (e.g., denoting a modulus) can output the modulus of the input quantity. The variable M can express, denote, or represent the total number of BSs 102/distributed nodes.

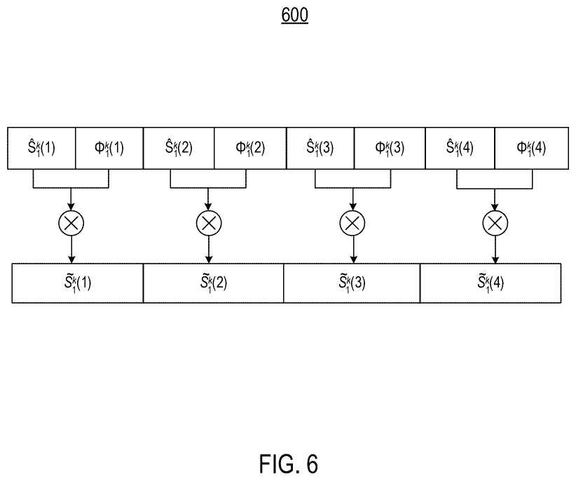

Referring to FIG. 6, depicted is an example operation 600 using Hadamard products. The procedure/operation 600 for generating a masked/precoded pilot sequence

$${\tilde{S}}_{1}^{k}$$

can be performed through/via the use of Hadamard product(s). In the example of FIG. 6, the BS 102 may be a distributed node “1”, and the length of

$${\hat{S}}_{m}^{k}$$

can be 4. The BS 102 can generate a masked/precoded pilot sequence

$${\tilde{S}}_{1}^{k}$$

by using the Hadamard products between

$${\hat{S}}_{1}^{k} and {Φ}_{1}^{k} = Φ ( {H}_{1}^{k} ) .$$

### Example Step for Feedback CSI Report

In various implementations, the UE 104 (or other UEs 104) can receive/obtain the DL sounding signal from the BS 102. Responsive to receiving the DL sounding signal, the UE 104 can determine signaling of indicating/reflecting channel correlation degree/level/magnitude (e.g., channel correlation information) between/associated with various UEs 104. The UE 104 can provide/signal/transmit a feedback message/information/data to the BS 102 after determining the signaling of indicating channel correlation information. In some cases, the channel correlation may be represented in the form of a matrix with certain dimensions. In some configurations, the matrix can include a dimension K×N, where K and N may respectively be the number of selected correlation coefficients between streams/layers of the UEs 104 and antennas/layers/streams of a specific UE 104. In some configurations, the matrix can include a dimension K×N×T, where K, N, and T can respectively be the number of selected correlation coefficients between streams/layers of UEs 104 and antennas/layers/streams of a specific UE 104 and/or a period of time or the number of basic time units. The feedback can include a channel state information (CSI) report related to or associated with the signaling of indicating channel correlation information.

For example, in certain environments/systems/scenarios, pilots in the DL sounding signal may be described/presented/indicated/represented as the following formula:

$${\tilde{Y}}^{k} = {H}^{k} {\tilde{S}}^{k} = ( {H}^{k} Φ ( {H}^{k} ) ) ⊗ {\hat{S}}^{k} = {\tilde{H}}^{k} ⊗ {\hat{S}}^{k} \qquad ( 4 )$$

Based on or according to \tilde{Y}^{k} an Ŝ^{k} (e.g., using formula (4)), the UE 104 (e.g., UEₖ) can obtain/acquire a channel correlation vector \tilde{H}^{k} from the following measurement quantity:

$${\tilde{H}}^{k} = {H}^{k} [ Φ ( {H}^{1} ) … Φ ( {H}^{{K}^{′}} ) ]$$

The K′ can denote the length of the channel correlation vector, which may represent or be regarded as at least a part of the feedback content of the UE 104 (e.g., UEₖ). In some configurations, the values of parameters k, K′, and K can be in the following order: 1≤k≤K′≤K (e.g., criteria for the values of k, K′, and K). The precoding (e.g., column) vector Φ(H^{k}) can be denoted/notated as follows:

$$Φ ( {H}^{k} ) = [ \begin{matrix}Φ ( {H}_{1}^{k} ) \\ ⋮ \\ Φ ( {H}_{m}^{k} ) \\ ⋮ \\ Φ ( {H}_{M}^{k} )\end{matrix} ]$$

In some implementations, before starting/performing/executing/initiating the UL feedback procedure, the parameter K′ can be predetermined/predefined and/or signaled/provided by the BS 102. In some configurations, the parameter K′ may be configured per individual UEs 104 (e.g., similar between certain UEs 104 or unique between UEs 104), such that the BS 102 can dynamically tune/update/refine this parameter for reaching a payload balance between UEs 104, for example. In some scenarios, the parameter K′ may be a common/shared parameter to all UEs 104, a group of UEs 104, or at least a number of UEs 104, for example.

As a response, the UE 104 (e.g., UEₖ) can determine a substitution vector to/of \tilde{H}ₖ. The UE 104 can send a parameter S associated with the vector \tilde{H}ₖ to the BS 102. In various implementations, one or more types of codebooks (e.g., precoding matrix) can be introduced/provided/indicated/configured to/for the BS 102 and/or the UE 104. Depending on the types of codebooks, the different features/operations can be performed by the BS 102 and/or the UE 104. In some cases, various codebook types may be predefined/pre-configured for the BS 102 and/or the UE 104. In some configurations, BS 102 may send/provide a control signaling to inform the UE 104 the codebook type to use.

For example, if a first codebook type (e.g., codebook type I, such as shown in Table 1) is introduced/provided, the BS 102 can determine a (codeword) vector indexed by K′ and v according to its similarity with \tilde{H}ₖ. The v can denote the feedback content from the UE 104 for the BS 102. The codeword index v can be a sub-signaling field and/or parameter included in/into the signaling of indicating channel correlation degree. In some cases, if Table 2 for a second codebook type (e.g., codebook type II) is employed/introduced, the UE 104 (e.g., UEₖ) can signal the parameter n=(n₁ . . . n_{K′}) to the BS 102, such as to form/construct/generate a vector quantizer for \tilde{H}ₖ. In this case, instead of codeword index v, an integer set n for vector quantizer can be carried/included in the signaling of indicating channel correlation degree, for example.

In some implementations, the combination of parameters n and c=(c₁ . . . c_{K′}) for a third codebook type (e.g., codebook type III exemplified by or shown in Table 3) can be signaled/provided/communicated by the UE 104 (e.g., UEₖ), such as to the BS 102 for instance, when amplitude factor is added in the quantization process of \tilde{H}ₖ. For instance, if the number of UEs 104 (e.g., users) scheduled for CSI feedback is 4, the UEₖ can be configured to calculate/compute/determine each H^{k}(Hⱼ)* and/or H^{j}(H^{k})* term/element, such as shown/provided in Table 4. The superscript k and j may be bounded by or associated with the number of scheduled UEs 104 and a predetermined set, respectively. In some implementations, index k can belong to or be included in a closed integer interval [1,4]. In this example, predetermined sets, e.g., {1, 2, 3, 4}, {2, 3, 4}, {3, 4}, and {4}, may be individually assigned to UE₁ UE₂ UE₃, and UE₄, under the condition/criteria/parameter of the set index being configured to 0 when the feedback pattern I in Table 5 is enabled. In some cases, if the feedback pattern II in Table 6 is enabled, the set index of each UE 104 can be flexibly/dynamically configured/adjusted/updated with one condition/requirement that the union/combination of predetermined sets of 4 UEs 104 is complete for reconstructing the Table 4 correlation matrix, for example.

In some implementations, continuing or referring to the above examples, if 6, 3, and 0 are respectively allocated as set indexes of UE₂, UE₃, and UE₄, the set index of UE₁ can be 7, thereby setting or enabling the terms to be indexed by (k=1, j=1), (k=1, j=2), (k=1, j=3), (k=1, j=4), (k=2, j=2), (k=2, j=3), (k=2, j=4), (k=3, j=3), (k=3, j=4), and (k=4, j=4). The UE 104 can provide feedback including the indexed terms to the BS 102. According to or using the terms, the BS 102 can generate/form/construct a channel correlation matrix.

In some configurations, when codebook type I and feedback pattern I are used/selected, the following vector may be constructed/generated, for instance, if the set index is 0.

$${u}_{1} = [ \begin{matrix}{{H}^{1} ( {H}^{1} )}^{*} \\ {H}^{1} {( {H}^{2} )}^{*} \\ {H}^{1} {( {H}^{3} )}^{*} \\ {H}^{1} {( {H}^{4} )}^{*}\end{matrix} ]$$

In some cases, the construction of (vector) u₁ may be terminated/canceled. Responsive to terminating the construction of u₁, the UE 104 (e.g., UE₁, continuing from prior examples) can proceed to search for/find/identify the same dimensional vector uᵥ, which minimizes a (norm) distance as follows:

$$d = {‖ {u}_{1} - {u}_{v} ‖}^{p} , p > 0$$

The underlying candidates for the vector uᵥ can be provided in Table 1. As discussed herein, the subscript v of vector uᵥ can be the information of transmitting to the BS 102/distributed node. Similarly to the above, for example, if codebook type II and feedback pattern II are selected, the vectors u₁ and uₙ can be generated as follows:

$${u}_{1} = [ \begin{matrix}{{H}^{1} ( {H}^{1} )}^{*} \\ {H}^{1} {( {H}^{2} )}^{*} \\ {H}^{1} {( {H}^{3} )}^{*} \\ {H}^{1} {( {H}^{4} )}^{*}\end{matrix} ] {u}_{n} = [ \begin{matrix}{e}^{- j 2 π \frac{{n}_{1}}{{N}_{1}}} \\ {e}^{- j 2 π \frac{{n}_{2}}{{N}_{2}}} \\ {e}^{- j 2 π \frac{{n}_{3}}{{N}_{3}}} \\ {e}^{- j 2 π \frac{{n}_{4}}{{N}_{4}}}\end{matrix} ]$$

In this example, the set index of feedback pattern II for UE₁ can be 7 and (N₁, N₂, N₃, N₄) may be predetermined. As a substitution of norm distance, the correlation coefficient can be considered and/or used for evaluating/determining the similarity level between u₁ and uₙ, e.g., represented as follows:

$${d}^{′} = {arg max}_{{n}_{1} , {n}_{2} , {n}_{3} , {n}_{4}} \frac{〈 {u}_{1} , {u}_{n} 〉}{‖ {u}_{1} ‖ ‖ {u}_{n} ‖}$$

In certain configurations, regardless of the metric used herein, (n₁, n₂, n₃, n₄) can be the quantity delivered/communicated/provided/sent by the UE 104 to the BS 102. In some cases, if the system (e.g., the BS 102 and/or the UE 104) supports the feedback patterns discussed hereinabove, a dedicated signaling from the UE 104 (and/or the BS 102) may be added for indicating which pattern is enabled/selected/indicated for the ongoing feedback. In various configurations, other combinations of the number of UEs 104, codebook types, and/or feedback patterns can be implemented, for instance, using features, operations, or techniques of the technical solution, and the relatively small/few numbers of examples are provided herein for simplicity.

TABLE 1
Codebook Type I
uᵥ

| K′ | v = 0 | | v = 1 | |
|---|---|---|---|---|
| 1 | [1] | | [−1] | |
| 2 | v = 0 | | v = 1 | |
| | $[ \begin{matrix}1 \\ j\end{matrix} ]$ | | $[ \begin{matrix}1 \\ - j\end{matrix} ]$ | |
| 3 | v = 0 | | v = 1 | |
| | $[ \begin{matrix}1 \\ ( 1 + j ) / \sqrt{2} \\ j\end{matrix} ]$ | | $[ \begin{matrix}1 \\ ( 1 - j ) / \sqrt{2} \\ j\end{matrix} ]$ | |
| 4 | v = 0 | v = 1 | v = 2 | v = 3 |
| | $[ \begin{matrix}1 \\ ( 1 + j ) / \sqrt{2} \\ j \\ ( 1 - j ) / \sqrt{2}\end{matrix} ]$ | $[ \begin{matrix}1 \\ ( 1 - j ) / \sqrt{2} \\ - j \\ ( - 1 - j ) / \sqrt{2}\end{matrix} ]$ | $[ \begin{matrix}1 \\ j \\ - 1 \\ - j\end{matrix} ]$ | $[ \begin{matrix}1 \\ - j \\ - 1 \\ j\end{matrix} ]$ |

TABLE 2
Codebook Type II
u

| K′ | |
|---|---|
| 1 | $[ {e}^{- j 2 π \frac{{n}_{1}}{{N}_{1}}} ] , {n}_{1} = 1 , 2 , … , {N}_{1}^{′} , {N}_{1}^{′} \leq {N}_{1}$ |
| 2 | $[ \begin{matrix}{e}^{- j 2 π \frac{{n}_{1}}{{N}_{1}}} \\ {e}^{- j 2 π \frac{{n}_{2}}{{N}_{2}}}\end{matrix} ] , \begin{matrix}{n}_{1} = 1 , 2 , … , {N}_{1}^{′} , {N}_{1}^{′} \leq {N}_{1} \\ {n}_{2} = 1 , 2 , … , {N}_{2}^{′} , {N}_{2}^{′} \leq {N}_{2}\end{matrix}$ |
| 3 | $[ \begin{matrix}{e}^{{- j 2 π \frac{{n}_{1}}{{N}_{1}}}_{}} \\ {e}^{- j 2 π \frac{{n}_{2}}{{N}_{2}}} \\ {e}^{- j 2 π \frac{{n}_{3}}{{N}_{3}}}\end{matrix} ] , \begin{matrix}{n}_{1} = 1 , 2 , … , {N}_{1}^{′} , {N}_{1}^{′} \leq {N}_{1} \\ {n}_{2} = 1 , 2 , … , {N}_{2}^{′} , {N}_{2}^{′} \leq {N}_{2} \\ {n}_{3} = 1 , 2 , … , {N}_{3}^{′} , {N}_{3}^{′} \leq {N}_{3}\end{matrix}$ |
| 4 | $[ \begin{matrix}{e}^{{- j 2 π \frac{{n}_{1}}{{N}_{1}}}_{}} \\ {e}^{- j 2 π \frac{{n}_{2}}{{N}_{2}}} \\ ⋮ \\ {e}^{- j 2 π \frac{{n}_{4}}{{N}_{4}}}\end{matrix} ] , \begin{matrix}{n}_{1} = 1 , 2 , … , {N}_{1} , {N}_{1}^{′} \leq {N}_{1} \\ {n}_{2} = 1 , 2 , … , {N}_{2} , {N}_{2}^{′} \leq {N}_{2} \\ {n}_{3} = 1 , 2 , … , {N}_{3} , {N}_{3}^{′} \leq {N}_{3} \\ {n}_{4} = 1 , 2 , … , {N}_{4} , {N}_{4}^{′} \leq {N}_{4}\end{matrix}$ |
| k′ | $[ \begin{matrix}{e}^{{- j 2 π \frac{{n}_{1}}{{N}_{1}}}_{}} \\ {e}^{- j 2 π \frac{{n}_{2}}{{N}_{2}}} \\ ⋮ \\ {e}^{- j 2 π \frac{{n}_{{k}^{′}}}{{N}_{{k}^{′}}}}\end{matrix} ] , \begin{matrix}{n}_{1} = 1 , 2 , … , {N}_{1}^{′} , {N}_{1}^{′} \leq {N}_{1} \\ {n}_{2} = 1 , 2 , … , {N}_{2}^{′} , {N}_{2}^{′} \leq {N}_{2} \\ ⋮ \\ {n}_{{k}^{′}} = 1 , 2 , … , {N}_{{k}^{′}}^{′} , {N}_{{k}^{′}}^{′} \leq {N}_{{k}^{′}}\end{matrix}$ |

TABLE 3
Codebook Type III
u

| K' | |
|---|---|
| 1 | $[ {c}_{1} {e}^{- j 2 π \frac{{n}_{1}}{{N}_{1}}} ] , {n}_{1} = 1 , 2 , … , {N}_{1}^{′} , {N}_{1}^{′} \leq {N}_{1}$ |
| 2 | $[ \begin{matrix}{c}_{1} {e}^{- j 2 π \frac{{n}_{1}}{{N}_{1}}} \\ {c}_{2} {e}^{- j 2 π \frac{{n}_{2}}{{N}_{2}}}\end{matrix} ] , \begin{matrix}{n}_{1} = 1 , 2 , … , {N}_{1}^{′} , {N}_{1}^{′} \leq {N}_{1} \\ {n}_{2} = 1 , 2 , … , {N}_{2}^{′} , {N}_{2}^{′} \leq {N}_{2}\end{matrix}$ |
| 3 | $[ \begin{matrix}{c}_{1} {e}^{- j 2 π \frac{{n}_{1}}{{N}_{1}}} \\ {c}_{2} {e}^{- j 2 π \frac{{n}_{2}}{{N}_{2}}} \\ {c}_{3} {e}^{- j 2 π \frac{{n}_{3}}{{N}_{3}}}\end{matrix} ] , \begin{matrix}{n}_{1} = 1 , 2 , … , {N}_{1}^{′} , {N}_{1}^{′} \leq {N}_{1} \\ {n}_{2} = 1 , 2 , … , {N}_{2}^{′} , {N}_{2}^{′} \leq {N}_{2} \\ {n}_{3} = 1 , 2 , … , {N}_{3}^{′} , {N}_{3}^{′} \leq {N}_{3}\end{matrix}$ |
| 4 | $[ \begin{matrix}{c}_{1} {e}^{- j 2 π \frac{{n}_{1}}{{N}_{1}}} \\ {c}_{2} {e}^{- j 2 π \frac{{n}_{2}}{{N}_{2}}} \\ ⋮ \\ {c}_{4} {e}^{- j 2 π \frac{{n}_{4}}{{N}_{4}}}\end{matrix} ] , \begin{matrix}{n}_{1} = 1 , 2 , … , {N}_{1}^{′} , {N}_{1}^{′} \leq {N}_{1} \\ {n}_{2} = 1 , 2 , … , {N}_{2}^{′} , {N}_{2}^{′} \leq {N}_{2} \\ {n}_{3} = 1 , 2 , … , {N}_{3}^{′} , {N}_{3}^{′} \leq {N}_{3} \\ {n}_{4} = 1 , 2 , … , {N}_{4}^{′} , {N}_{4}^{′} \leq {N}_{4}\end{matrix}$ |
| k' | $[ \begin{matrix}{c}_{1} {e}^{- j 2 π \frac{{n}_{1}}{{N}_{1}}} \\ {c}_{2} {e}^{- j 2 π \frac{{n}_{2}}{{N}_{2}}} \\ ⋮ \\ {c}_{{k}^{′}} {e}^{- j 2 π \frac{{n}_{{k}^{′}}}{{N}_{{k}^{′}}}}\end{matrix} ] , \begin{matrix}{n}_{1} = 1 , 2 , … , {N}_{1}^{′} , {N}_{1}^{′} \leq {N}_{1} \\ {n}_{2} = 1 , 2 , … , {N}_{2}^{′} , {N}_{2}^{′} \leq {N}_{2} \\ ⋮ \\ {n}_{{k}^{′}} = 1 , 2 , … , {N}_{{k}^{′}}^{′} , {N}_{{k}^{′}}^{′} \leq {N}_{{k}^{′}}\end{matrix}$ |

TABLE 4
(Channel) Correlation Matrix

| UE Index | 1 | 2 | 3 | 4 |
|---|---|---|---|---|
| 1 | H¹(H¹)* | H¹(H²)* | H¹(H³)* | H¹(H⁴)* |
| 2 | H²(H¹)* | H²(H²)* | H²(H³)* | H²(H⁴)* |
| 3 | H³(H¹)* | H³(H²)* | H³(H³)* | H³(H⁴)* |
| 4 | H⁴(H¹)* | H⁴(H²)* | H⁴(H³)* | H⁴(H⁴)* |

TABLE 5
Feedback Pattern I

| Set | User Index | | | |
|---|---|---|---|---|
| Index | 1 | 2 | 3 | 4 |
| 0 | j = {1, 2, 3, 4} | j = {2, 3, 4} | j = {3, 4} | j = {4} |
| 1 | j = {1, 3} | j = {1, 2, 3, 4} | j = {3, 4} | j = {1, 4} |
| 2 | j = {1} | j = {1, 2, 4} | j = {1, 2, 3, 4} | j = {1, 4} |
| 3 | j = {1, 2} | j = {2, 3} | j = {1, 3} | j = {1, 2, 3, 4} |
| 4 | j = {1, 2} | j = {2, 3, 4} | j = {1, 3, 4} | j = {1, 4} |

TABLE 6
Feedback Pattern II

| Set Index | 1 | 2 | 3 | 4 |
|---|---|---|---|---|
| 0 | j = {1} | j = {2} | j = {3} | j = {4} |
| 1 | j = {1, 2} | j = {1, 2} | j = {1, 3} | j = {1, 4} |
| 2 | j = {1, 3} | j = {2, 3} | j = {2, 3} | j = {2, 4} |
| 3 | j = {1, 4} | j = {2, 4} | j = {3, 4} | j = {3, 4} |
| 4 | j = {1, 2, 3} | j = {1, 2, 3} | j = {1, 2, 3} | j = {1, 2, 4} |
| 5 | j = {1, 2, 4} | j = {1, 2, 4} | j = {1, 3, 4} | j = {1, 3, 4} |
| 6 | j = {1, 3, 4} | j = {2, 3, 4} | j = {2, 3, 4} | j = {2, 3, 4} |

| | |
|---|---|
| 7 | j = {1, 2, 3, 4} |

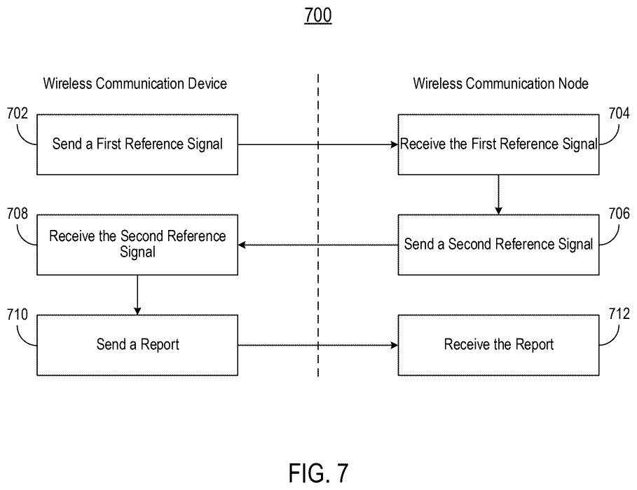

Referring now to FIG. 7, depicted is a flow diagram of an example method 700 for channel sounding and channel state information (CSI) feedback for distributed MIMO precoding. The method 700 can be performed or implemented by one or more network elements (e.g., at least one UE 104 and at least one BS 102/distributed node), such as described in conjunction with FIGS. 1-6. In overview, the method 700 can include sending a first reference signal, at operation 702. At operation 704, the method 700 can include receiving the first reference signal. At operation 706, the method 700 can include sending a second reference signal. At operation 708, the method 700 can include receiving the second reference signal. At operation 710, the method 700 can include sending a report. At operation 712, the method 700 can include receiving the report.

Still referring to FIG. 7, and in further details, at operation 702, at least one of various wireless communication devices (e.g., a first UE of multiple UEs) can send/transmit/provide/signal/communicate a first reference signal (e.g., sounding reference signal (SRS)) to a wireless communication node (e.g., BS, gNB, TRP, distributed node, local node, or access point (AP)).

At operation 704, the wireless communication node can receive/obtain the first reference signal from the wireless communication device. In various implementations, the first reference signal can include or correspond to a sounding reference signal (SRS).

At operation 706, the wireless communication node can send a second reference signal to the wireless communication device. At operation 708, the wireless communication device can receive the second reference signal from the wireless communication node. In various implementations, the second reference signal can include or correspond to a channel state information reference signal (CSI-RS).

At operation 710, the wireless communication device can send a report (e.g., feedback) to the wireless communication node. The report can include signaling of indicating channel correlation information associated with the plurality of wireless communication devices (e.g., signaling of reflecting channel correlation degree between wireless communication devices or users). At operation 712, the wireless communication node can receive the report from the wireless communication device, thereby avoiding information exchanges with other wireless communication nodes (e.g., between wireless communication nodes), for example.

In various implementations, the channel correlation information can include a matrix with dimensions (e.g., vectors). In some configurations, at least one of the dimensions of the matrix may be determined based on or according to a number of the wireless communication devices, for instance, to reduce/minimize feedback overhead. In some configurations, at least one of the dimensions may be relevant with a number of antennas, streams, and/or panels of any of the wireless communication devices.

In some configurations, at least one of the dimensions may be determined based on a number (e.g., K′) configured by the wireless communication node for the first wireless communication device, among other wireless communication devices. In some configurations, the matrix can be comprised/composed of multiple codebook vectors (e.g., codebook type I, etc.). In some configurations, the matrix can be comprised/composed of various quantized vectors (e.g., codebook type II, codebook type III, etc.).

In some configurations, the signaling may include/comprise of various indices mapping to mapping to bases for representing channel correlation information, for instance, to reduce the feedback overhead. In some configurations, the signaling may include multiple parameters for quantizing channel correlation information, such as for trade-off between feedback overhead and information accuracy.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method, comprising:
sending, by a first wireless communication device to a wireless communication node, a first reference signal, wherein the first reference signal comprises a Sounding Reference Signal (SRS);
receiving, by the first wireless communication device from the wireless communication node, a second reference signal, wherein the second reference signal comprises a precoded Channel State Information Reference Signal (CSI-RS); and
sending, by the first wireless communication device to the wireless communication node, a report comprising signaling of indicating channel information associated with a plurality of wireless communication devices, wherein the first wireless communication device is one of the plurality of wireless communication devices, and the channel information comprises a matrix with dimensions.

2. (canceled)

3. (canceled)

4. (canceled)

5. The wireless communication method of claim 1, wherein at least one of the dimensions are determined based on a number of the plurality of wireless communication devices.

6. The wireless communication method of claim 1, wherein at least one of the dimensions is relevant with a number of antenna, streams, or layers of any of the plurality of wireless communication devices.

7. The wireless communication method of claim 1, wherein at least one of the dimensions is determined based on a number configured by the wireless communication node for the first wireless communication device.

8. The wireless communication method of claim 1, wherein the matrix is comprised of a plurality of codebook vectors.

9. The wireless communication method of claim 1, wherein the matrix is comprised of a plurality of quantized vectors.

10. The wireless communication method of claim 1, wherein the signaling comprises a plurality of indices mapping to bases for representing the channel information.

11. The wireless communication method of claim 1, wherein the signaling comprises a plurality of parameters for quantizing the channel information.

12. A wireless communication method, comprising:
receiving, by a wireless communication node from each of a plurality of wireless communication devices, a first reference signal, wherein the first reference signal comprises a Sounding Reference Signal (SRS);
sending, by the wireless communication node to at least a first one of the plurality of wireless communication devices, a second reference signal, wherein the second reference signal comprises a precoded Channel State Information Reference Signal (CSI-RS); and
receiving, by the wireless communication node from the first wireless communication device, a report comprising signaling of indicating channel information associated with the plurality of wireless communication devices, wherein the channel information comprises a matrix with dimensions.

13. A first wireless communication device, comprising at least one processor configured to:
send a first reference signal to a wireless communication node, wherein the first reference signal comprises a Sounding Reference Signal (SRS);
receive a second reference signal from the wireless communication node, wherein the second reference signal comprises a precoded Channel State Information Reference Signal (CSI-RS); and
send a report comprising signaling of indicating channel information associated with a plurality of wireless communication devices to the wireless communication node, wherein the channel information comprises a matrix with dimensions.

14. (canceled)

15. The first wireless communication device of claim 13, wherein at least one of the dimensions are determined based on a number of the plurality of wireless communication devices.

16. The first wireless communication device of claim 13, wherein at least one of the dimensions is relevant with a number of antenna, streams, or layers of any of the plurality of wireless communication devices.

17. The first wireless communication device of claim 13, wherein at least one of the dimensions is determined based on a number configured by the wireless communication node for the first wireless communication device.

18. The first wireless communication device of claim 13, wherein the matrix is comprised of a plurality of codebook vectors.

19. The first wireless communication device of claim 13, wherein the matrix is comprised of a plurality of quantized vectors.

20. The first wireless communication device of claim 13, wherein the signaling comprises a plurality of indices mapping to bases for representing the channel information.

21. The first wireless communication device of claim 13, wherein the signaling comprises a plurality of parameters for quantizing the channel information.

22. A wireless communication node, comprising:
at least one processor configured to implement the method as claimed in claim 12.

23. The wireless communication method of claim 12, wherein at least one of the dimensions are determined based on a number of the plurality of wireless communication devices.

24. The wireless communication method of claim 12, wherein at least one of the dimensions is relevant with a number of antenna, streams, or layers of any of the plurality of wireless communication devices.
